(19) United States
(12) Patent Application Publication
(10) Pub. No.: US 2008/0264544 A1
(43) Pub. Date: Oct. 30, 2008

(54) Foamed thermoplastic resin molding with a functional component

(75) Inventor: Nobuhiro Usui, Ichihara-shi (JP)

Correspondence Address: FITCH, EVEN, TABIN & FLANNERY, P. O. BOX 18415, WASHINGTON, DC, 20036, US

(73) Assignee: Sumitomo Chemical Company, Limited, Osaka (JP)

(21) Appl. No.: 12/081,393

(22) Filed: Apr. 15, 2008

Related U.S. Application Data
(62) Division of application No. 10/357,466, filed on Feb. 4, 2003.

(30) Foreign Application Priority Data
Feb. 12, 2002 (JP) 2002-033524

(51) Int. Cl. B29C 65/06

(52) U.S. Cl. 156/73.5

(57) ABSTRACT

Disclosed is a foamed resin molding with a functional component obtained by
supplying a molten resin locally to the backside of a foamed resin molding made of a preliminarily-shaped foamed laminate sheet having a foamed base layer made of a foamed resin sheet, the foamed base layer having on at least one side thereof a skin layer laminated, and
shaping the molten resin into a functional component and simultaneously integrating the functional component to the foamed resin molding by welding, wherein the following inequality is satisfied:

1<X<3{(t1/E)+t2}

where t1 is a thickness of the foamed base layer in the portion where the functional component is integrated, E is an expansion ratio of the foamed base layer, t2 is a thickness of the skin layer, and X is a width of the welded portion of the functional component to the foamed base layer.

### BACKGROUND OF THE INVENTION

1. Field of the Invention

The present invention relates to a foamed thermoplastic resin molding to which a functional component, e.g. a rib and a boss, is integrated by welding. In the following description, such a foamed thermoplastic resin molding having a functional component may sometimes be referred to as a functionalized foamed thermoplastic resin molding.

2. Description of the Related Art

Foamed thermoplastic resin moldings comprising a foamed base layer comprising a foamed thermoplastic resin sheet, the foamed base layer having on at least one side thereof a skin layer laminated, have conventionally been used widely in various fields typified by automotive interior parts such as automotive cabin interior parts, e.g. door trims, pillar trims and quarter trims, and automotive trunk interior parts.

When such foamed thermoplastic resin moldings are used as various kinds of interior parts for automobiles and the like, such products have on their backsides functional components such as ribs for reinforcement and bosses and clips for mounting the products to a vehicle body as disclosed in JP,A 2001-121561.

As a method for attaching a functional component, there is a method in which a functional component formed in advance is fixed to a back surface of a foamed thermoplastic resin molding with an adhesive or the like. However, this technique is problematic in environmental aspect or in cost and adhesive strength. Therefore, there have been known, for example, as disclosed in the above-cited JP,A 2001-121561,

a method which comprises supplying a skin material-laminated foamed thermoplastic resin sheet which has been formed into a predetermined shape to a space between paired mold halves at least one of which has a recess corresponding to the shape of a functional component, supplying a molten thermoplastic resin to the recess through a molten resin passageway formed in the mold half having the recess and shaping the molten resin into the functional component in the recess, thereby integrating the functional component of the thermoplastic resin to a foamed thermoplastic resin base layer by welding, and

a method which comprises supplying a skin material-laminated foamed thermoplastic resin sheet to a space between paired mold halves at least one of which has a recess corresponding to the shape of a functional component, supplying a molten thermoplastic resin to the recess through a molten resin passageway formed in the mold half having the recess at the same time or after the foamed thermoplastic resin sheet is formed into a predetermined shape with the mold halves, shaping the molten thermoplastic resin into the form of the functional component, thereby integrating the functional component of the thermoplastic resin to a foamed thermoplastic resin base layer.

Such methods have advantages of causing less variation in pull-off strength of functional components from foamed thermoplastic resin sheets and causing no work environment problems. However, there is a problem, with the foamed thermoplastic resin moldings having a functional component produced by those methods, in that a depression (sink mark) is formed locally in the surface of a molding corresponding to the portion where a functional component is formed as shown in FIG. 1(a).

### SUMMARY OF THE INVENTION

Under such situations, to develop a foamed thermoplastic resin molding which is obtainable by the above-mentioned method and which forms no sink marks (depressions) locally in a surface of the molding corresponding to the portion where a functional component has been formed, the present inventors made various investigations about the cause of the formation of sink marks in the foamed thermoplastic resin molding obtained by the above-mentioned method. As a result, they have accomplished the present invention after finding that the main factor of the formation of sink marks is a design issue relating to the thickness of the foamed base layer, the expansion ratio of the foamed base layer, the thickness of the skin layer in the foamed laminate sheet and the width of the welded portion of the functional component to the foamed base layer, and that when the width of the welded portion of the functional component to the foamed base layer meets a specific relation with the foregoing factors, a foamed thermoplastic resin molding can be obtained which forms no sink marks and has a good appearance.

The present invention provides a foamed thermoplastic resin molding with a functional component obtained by:

supplying a molten thermoplastic resin locally to the backside of a foamed thermoplastic resin molding obtained by forming a foamed laminate sheet into a predetermined shape, which foamed laminate sheet comprises a foamed base layer comprising a foamed thermoplastic resin sheet, the foamed base layer having on at least one side thereof a skin layer laminated, and shaping the molten thermoplastic resin into a functional component and simultaneously integrating the functional component to the foamed thermoplastic resin molding by welding, wherein the following inequality is satisfied:

1<X<3{(t1/E)+t2}

where t1 (mm) is a thickness of the foamed base layer in the portion where the functional component is integrated, E is an expansion ratio of the foamed base layer, t2 (mm) is a thickness of the skin layer, and X (mm) is a width of the welded portion of the functional component to the foamed base layer.

### BRIEF DESCRIPTION OF DRAWINGS

In the drawings,

FIG. 1 shows an example of a partial sectional view of a foamed thermoplastic resin molding having a functional component on its backside; (a) is an example where the requirements of the present invention are not satisfied and (b) is an example where the requirements of the present invention are satisfied,

FIG. 2 shows an example of a sectional view of a foamed laminate sheet which constitutes a foamed thermoplastic resin molding of the present invention,

FIG. 3 shows a schematic sectional view of a mold illustrating an example of a process for attaching a functional component to a backside of a foamed thermoplastic resin molding of the present invention,

FIG. 4 shows a schematic sectional view of a mold illustrating an example of a process for attaching a functional component to a backside of a foamed thermoplastic resin molding of the present invention, and

FIG. 5 shows an example of a partial sectional view of a foamed thermoplastic resin molding indicating the positions of each factor in the relation defined in the present invention.

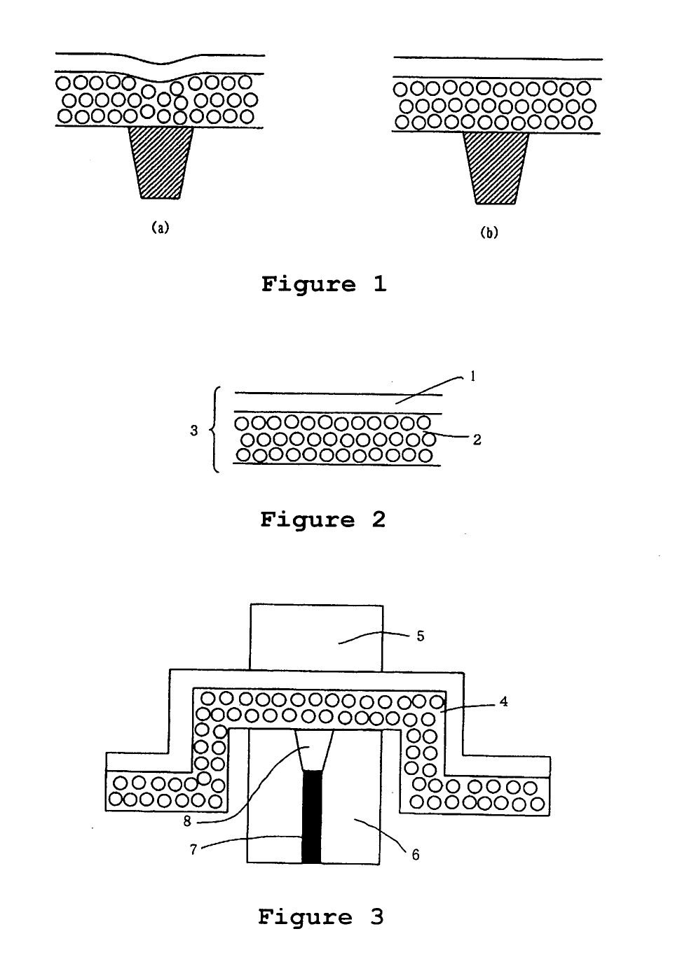

1: Skin layer; 2: Foamed base layer; 3: Foamed laminate sheet; 4: Foamed thermoplastic resin molding; 5: Die A; 6: Die B; 7: Molten resin supply passageway; 8: Recess corresponding to functional component; 9: Female mold half; 10: Male mold half; 11: Molten resin supply passageway; 12: Recess corresponding to functional component; X: Width of welded portion of functional component; E: Expansion ratio of foamed base layer; t1: Thickness of foamed base layer; t2: Thickness of skin layer.

### DESCRIPTION OF PREFERRED EMBODIMENTS

The present invention concerns a functionalized foamed thermoplastic resin molding with a functional component obtained by:

supplying a molten thermoplastic resin locally to the backside of a foamed thermoplastic resin molding obtained by forming a foamed laminate sheet into a predetermined shape, which foamed laminate sheet comprises a foamed base layer comprising a foamed thermoplastic resin sheet, the foamed base layer having on at least one side thereof a skin layer laminated, and

shaping the molten thermoplastic resin into a functional component and simultaneously integrating the functional component to the foamed thermoplastic resin molding by welding.

In the foamed base layer comprising a foamed thermoplastic resin sheet which will become a material for forming the foamed thermoplastic resin molding of the present invention, the foamed thermoplastic resin sheet may be formed of one kind of thermoplastic resin and may also comprise two or more kinds of thermoplastic resins.

The foamed base layer may comprise only a single layer or may also be formed of a multilayer foamed sheet in which a plurality of foamed layers, which may be of the same kind or of different kinds, are laminated. Alternatively, it may also be formed of a multilayer foamed sheet having a non-foamed layer on at least one side of a foamed sheet.

Examples of the thermoplastic resin constituting the foamed thermoplastic resin sheet include polyethylene resins, polypropylene resins, polystyrene resins, polyethylene terephthalate resins, polyvinyl alcohol resins, vinyl chloride-based resins, ionomer resins and acrylonitrile/butadiene/styrene resins or the like.

Of such thermoplastic resins, preferred are olefinic resins, in particular, propylene-based resins from the viewpoints of heat resistance and cost.

Preferable propylene-based resins include, for example, homopolymers of propylene and copolymers containing 50 mole % or more of propylene units. Preferable examples of components copolymerized with propylene in the aforementioned copolymers include ethylene and α-olefin. Examples of α-olefin include α-olefins having from 4 to 10 carbon atoms such as 1-butene, 4-methylpentene-1,1-hexene and 1-octene. The content of monomer units of copolymerization components other than propylene in the copolymers is preferably not more than 10% by weight for ethylene and not more than 30% by weight for α-olefins.

With regard to such propylene-based resins, those in which long-chain branches have been introduced by low-level electron beam crosslinking such as those disclosed in JP,A 62-121704 and propylene-based resins in which ultra high molecular weight components have been introduced are also used preferably.

In the foamed thermoplastic resin molding of the present invention, assuming that the thickness of the foamed base layer in the portion where the functional component is integrated is t1 (mm), the expansion ratio of the foamed base layer is E, the thickness of the skin layer is t2 (mm), and the width of a welded portion of the functional component to the foamed base layer is X (mm), it is necessary that the individual factors are set so as to satisfy the following formula:

1<X<3{(t1/E)+t2}

Namely, in foamed thermoplastic resin moldings of the present invention produced by the above-described method, the smaller the width of a welded portion of the functional component to the base layer, the less the effect on occurrence of sink marks.

However, it is necessary that the width of the welded portion is at least 1 mm or more from the viewpoint of adhesion strength. On the other hand, when the width of the welded portion, X, is large, the local occurrence of sink marks in the surface of a molding corresponding to the portion where a functional component is formed is affected by the thickness of the foamed base layer t1 (mm), the expansion ratio of the foamed base layer E and the thickness of the skin layer t2 (mm). Moreover, since these factors interact with each other, that problem can not be eliminated by choice of a single factor and it is necessary to design the individual factors so that the width of the welded portion X becomes less than 3{(t1/E)+t2} in relation with the individual factors.

For example, when a certain condition has already been set so that those factors satisfy the above requirement, the width of a weld of a functional component to a foamed base layer must be 1 mm or more depending, for example, on the shape and usage conditions of the functional component. When the thickness of the foamed base layer is also specified, other factors, i.e. the expansion ratio of the foamed base layer and the thickness of the skin layer, must be appropriately selected to be properly combined so as to satisfy the aforementioned formula. Under conditions deviating from the above-mentioned formula, a sink mark will appear in the surface of the foamed base layer opposite to functional component.

The expansion ratio of the foamed base layer used herein means an average expansion ratio of the region including at least the part where the functional component is formed and a peripheral region thereof. It has no relation to the expansion ratios of edge portions of a product, which are not directly associated with sink marks caused by welding of functional components.

The expansion ratio of the foamed base layer is not particularly limited as long as it satisfies the above-mentioned relation and can be optionally chosen depending on the products desired. However, the expansion ratio of a foamed sheet is preferably not more than 10 times from the viewpoint of rigidity of products, and not less than two times from the viewpoint of weight reduction of products.

The thickness of a foamed base layer indicates the thickness obtained by subtracting the thickness of a skin layer from the thickness of a foamed laminate sheet having thereon the skin layer laminated. Like the expansion ratio, it is not particularly limited as long as it satisfies the relation mentioned above and can be chosen arbitrarily. However, the foamed base layer preferably has a thickness of from 1 mm to 10 mm from the viewpoint of strength and ease to handle of sheets.

The functional component comprising a thermoplastic resin in the present invention is formed so as to project from the backside of the foamed laminate sheet. Specific examples thereof include ribs for reinforcing the aforementioned foamed thermoplastic resin moldings and bosses, clips and hooks for mounting the foamed thermoplastic resin moldings to other members.

The shape of a section of the functional component may be chosen arbitrarily depending upon the function desired. However, the width of a welded portion where the functional component is attached by welding to a foamed thermoplastic resin molding must satisfy the formula of the present invention.

The width of the welded portion is the width (length) of the attaching portion of the functional component abutting on the backside of the foamed molding. When the attaching portion is curved, the width of the welded portion means the length of a line connecting intersections of each tangential line (extension line) of the functional component along the height thereof and the surface of the foamed molding.

The thermoplastic resin for forming the functional component may be chosen appropriately depending upon the kind of the thermoplastic resin for forming the foamed thermoplastic resin sheet to which the functional component is to be attached by welding. Examples of the thermoplastic resins which can be preferably used include polyethylene resins, polypropylene resins, polyester resins, polyethylene terephthalate resins, polyvinyl alcohol resins, vinyl chloride resins, ionomer resins, polyamide resins, acrylonitrile/butadiene/styrene resins, polycarbonate resins, their modified products, and polymer alloys comprising two or more of those resins.

The functional component may be formed of only one kind of thermoplastic resin or may be formed of two or more kinds of thermoplastic resins. The thermoplastic resin for forming the functional component is preferably a thermoplastic resin compatible with the thermoplastic resin of the foamed sheet from the viewpoint of strength of attachment by welding to a foamed thermoplastic resin sheet.

The thermoplastic resin for forming the functional component may contain various kinds of filler (e.g. inorganic fibers such as glass fiber and carbon fiber, inorganic particles such as talc, clay, silica and calcium carbonate, and the like). Moreover, various kinds of additives e.g. antioxidants, colorants, flame retarders and shrinkage reducers may be incorporated.

In the foamed thermoplastic resin molding of the present invention, the position and the number of the functional component to be formed are not particularly limited as long as the functional component is formed on the backside of the molding.

The skin layer which is laminated on at least one side of the foamed base layer comprising the foamed thermoplastic resin sheet in the foamed may be woven fabric, non-woven fabric, knitted fabric, sheet, film, foam, or the like.

The material for forming the skin layer is not particularly limited. For example, thermoplastic resins such as polyolefin resins, polyvinyl chloride resins and polystyrene resins, thermosetting resins such as polyurethane resins, rubbers or thermoplastic elastomers such as cis-1,4-polybutadiene and ethylene/propylene copolymers can be used. The skin layer may be provided with uneven patterns such as grain, printing and dyeing. The skin layer may be composed of a single layer or may have a multilayer structure composed of two or more layers. Moreover, a skin layer may have a cushion layer for imparting a soft feel.

The skin layer is, in many cases, disposed on the front surface of the foamed thermoplastic resin molding, but it may be disposed also on the backside where the functional component is attached by welding as well as the front surface of the product.

The skin layer of the backside is only required to be a porous layer such that the functional component can be attached by welding to the foamed base layer through the skin layer of the backside. The skin layer of the backside may be of woven fabric, non-woven fabric, net-like material, or the like. Examples of the material for constituting the porous skin layer of the backside include thermoplastic resins such as polyolefin resins, polyester resins, polyamide resins and polystyrene resins, natural fibers such as cellulose fibers e.g. cotton, hemp and bamboo, and materials obtained by blending these various fibers.

When both sides of the foamed base layer comprising a foamed thermoplastic resin sheet are laminated with skin layers, “t2” in the formula mentioned above is defined as the sum of the thickness of the skin layer in the front surface of the product and the thickness of the skin layer in the backside of the product.

The thickness of the skin layer may be chosen arbitrarily depending upon products desired. With regard to the method of laminating the skin layer and the foamed base layer, they can be laminated by conventional lamination methods such as using an adhesive or welding.

Regarding the method for forming a foamed laminate sheet comprising a foamed thermoplastic resin sheet base layer and a skin layer laminated together into the shape of a product, a foamed laminate sheet (3) comprising a skin layer (1) and a foamed thermoplastic resin sheet base layer (2), shown in FIG. 2, is preliminarily heated to soften and then the foamed laminate sheet softened is formed into a predetermined foamed thermoplastic resin molding by conventional methods for forming a sheet material such as vacuum forming, vacuum/pressure forming and various types of press molding.

With regard to the method for forming a functional component such as a rib and a clip on the backside of a foamed thermoplastic resin molding, for example, a functional component can be formed on a foamed thermoplastic resin molding (4), for example, by a method comprising:

holding, as illustrated in FIG. 3, a foamed thermoplastic resin molding (4) obtained by forming a foamed laminate sheet previously into a predetermined shape by vacuum forming, vacuum/pressure forming, press molding or the like, between a die A (5) and a die B (6) having a molten resin supply passageway (7) and a recess (8) having a configuration corresponding to that of a functional component to be formed, and

subsequently supplying a molten resin to the recess (8) having the configuration of the functional component through the molten resin supply passageway (7) to shape the resin.

As another method, it is also possible to press mold a foamed laminate sheet (3) which has previously been heated to soften into a predetermined shape by use of a male mold half (10) and a female mold half (9), and supply, at the same time as or after the molding, a molten resin into a recess (12) corresponding to the shape of a functional component through a molten resin supply passageway (11) formed in the male or female mold half so as to shape the molten resin, thereby forming the foamed laminate sheet into a foamed thermoplastic resin molding and simultaneously forming the functional component on the backside of the molding.

In the above-mentioned example, described was a method for integrally forming a functional component in the case where a foamed laminate sheet is shaped by use of press molding. However, it is also possible to use a mold the same as that described above which has a resin supply passageway and a recess with a configuration of a functional component and form a foamed laminate sheet into a foamed thermoplastic resin molding with the mold by vacuum forming, vacuum/pressure forming or the like, thereby forming the functional component on the backside of the molding.

The foamed thermoplastic resin molding of the present invention having a functional component has no sink marks (depressions) locally in a surface of the molding corresponding to the portion where the functional component is formed and has a good appearance. In addition, it can be manufactured easily in an industrial production.

### EXAMPLES

The present invention will be further described by reference to examples below, but the invention is not restricted to these examples.

### Example 1

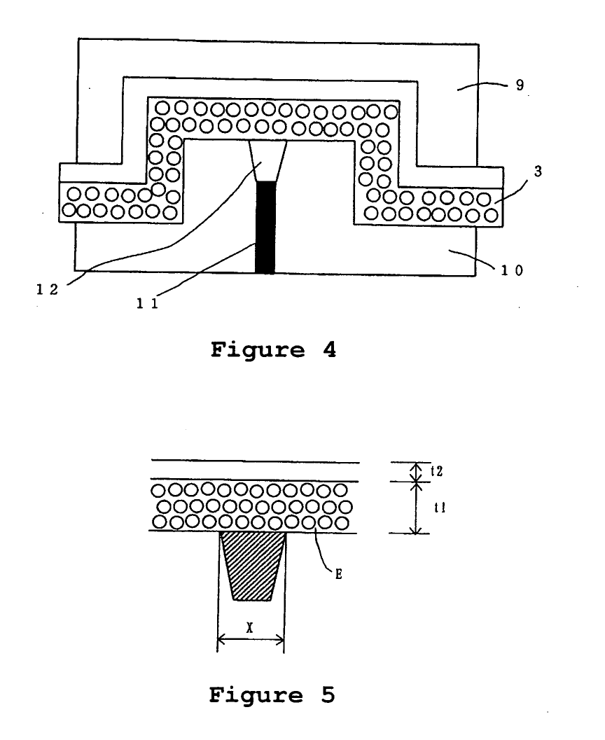

In this example, used was a paired press mold (size of molding surface: length 300 mm, width 300 mm, height 10 mm) comprising a female mold half (9) and a male mold half (10) having a recess (12) having configuration corresponding to the shape of a rib to be formed and a molten resin passageway (11), shown in FIG. 4.

Used as a foamed laminate was a foamed laminate sheet obtained by thermally laminating a foamed polypropylene sheet (SUMICELLER foamed PP sheet 3030 available from Sumika Plastech Co., Ltd.; expansion ratio (E)=3 times, thickness (t1)=3 mm) with an olefinic thermoplastic elastomer sheet (available from Kyowa Leather Co., Ltd.; thickness (t2)=0.35 mm).

The foamed laminate sheet was heated to 130° C. in an oven and was placed on the male mold half (10) adjusted to 30° C. The foamed laminate sheet was then formed into a predetermined shape by closing the mold by moving the female mold half (9) toward the male mold half until the interval between the molding surfaces of the mold halves became 3.35 mm.

Thirty seconds after the completion of the shaping, the foamed molding comprising the foamed laminate sheet was cooled in the mold. Subsequently, a polypropylene resin (available from Sumitomo Chemical Co., Ltd. available as Sumitomo Noblen AZ564; melt flow rate=30 g/10 minutes) molten at 200° C. was supplied to the recess (12) having configuration corresponding to the shape of a rib through the resin passageway (11) formed in the male mold half while keeping the mold closed, thereby being shaped.

After the completion of the shaping, cooling was carried out for 20 seconds. When the male and female mold halves were opened a foamed molding was obtained which had on its backside a rib attached by welding.

The width (X) of the welded portion of the rib (functional component) in the resulting molding was 4 mm. When the above-mentioned conditions are applied to the formula of the present invention, 1<X=4<4.05, which satisfies the relation defined in the present invention. The resulting foamed molding had no sink marks (depressions) and had a good appearance.

### Example 2

A foamed molding having on its backside a rib attached by welding was obtained in the same manner as Example 1 except that a foamed laminate sheet obtained by thermally laminating a foamed polypropylene sheet (SUMICELLER foamed PP sheet 4030 available from Sumika Plastech Co., Ltd.; expansion ratio (E)=4 times, thickness (t1)=3 mm) with an olefinic thermoplastic elastomer sheet (available from Kyowa Leather Co., Ltd.; thickness (t2)=0.6 mm) was used in place of the foamed laminate sheet used in Example 1 and that mold closure was carried out until the interval between the molding surfaces of the male and female mold halves reached 3.6 mm.

The width (X) of the welded portion of the rib (functional component) in the resulting molding was 4 mm. When the above-mentioned conditions are applied to the formula of the present invention, 1<X=4<4.05, which satisfies the relation defined in the present invention. The resulting foamed molding had no sink marks (depressions) and had a good appearance.

### Comparative Example 1

A foamed molding having on its backside a rib attached by welding was obtained in the same manner as Example 1 except that a foamed laminate sheet obtained by thermally laminating a foamed polypropylene sheet (SUMICELLER foamed PP sheet 4030 available from Sumika Plastech Co., Ltd.; expansion ratio (E)=4 times, thickness (t1)=3 mm) with an olefinic thermoplastic elastomer sheet (available from Kyowa Leather Co., Ltd.; thickness (t2)=0.35 mm) was used in place of the foamed laminate sheet used in Example 1.

The width (X) of the welded portion of the rib (functional component) in the resulting molding was 4 mm. When the above-mentioned conditions are applied to the formula of the present invention, 1<X=4>3.3, which does not satisfy the relation defined in the present invention. The resulting foamed molding had a sink mark (depression) in a surface thereof.

### Comparative Example 2

A foamed molding having on its backside a rib attached by welding was obtained in the same manner as Example 1 except that a foamed laminate sheet obtained by thermally laminating a foamed polypropylene sheet (SUMICELLER foamed PP sheet 3020 available from Sumika Plastech Co., Ltd.; expansion ratio (E)=3 times, thickness (t1)=2 mm) with an olefinic thermoplastic elastomer sheet (available from Kyowa Leather Co., Ltd.; thickness (t2)=0.6 mm) was used in place of the foamed laminate sheet used in Example 1 and that mold closure was carried out until the interval between the molding surfaces of the male and female mold halves reached 2.6 mm.

The width (X) of the welded portion of the rib (functional component) in the resulting molding was 4 mm. When the above-mentioned conditions are applied to the formula of the present invention, 1<X=4>3.8, which does not satisfy the relation defined in the present invention. The resulting foamed molding had a sink mark (depression) in a surface thereof.

1. (canceled)

2. (canceled)

3. (canceled)

4. (canceled)

5. A method for producing a foamed thermoplastic resin molding with a functional component, the method comprising:
supplying a molten thermoplastic resin locally to the backside of a foamed thermoplastic resin molding obtained by forming a foamed laminate sheet into a predetermined shape, wherein the foamed laminate sheet comprises a foamed base layer comprising a foamed thermoplastic resin sheet and the foamed base layer has on at least one side thereof a skin layer laminated, and
shaping the molten thermoplastic resin into a functional component and a simultaneously integrating the functional component to the foamed thermoplastic resin molding by welding, wherein the following inequality is satisfied:
1<X<3{(t1/E)+t2}
wherein t1 (mm) is a thickness of the foamed base layer in the portion where the functional component is integrated, E is an expansion ratio of the foamed base layer, t2 (mm) is a thickness of the skin layer, and X (mm) is a width of the welded portion of the functional component to the foamed base layer.

6. The method according to claim 5, wherein the foamed base layer has an expansion ratio of from 2-10.
